(19) United States
(12) Patent Application Publication
(10) Pub. No.: US 2014/0013713 A1
(43) Pub. Date: Jan. 16, 2014

(54) CONVENIENT DISPOSAL CONTAINER

(71) Applicant: Dawn L. Boettcher, Richfield, MN (US)

(72) Inventor: Dawn L. Boettcher, Richfield, MN (US)

(21) Appl. No.: 13/545,042

(22) Filed: Jul. 10, 2012

(51) Int. Cl. B65F 1/14; B65B 43/26; B65D 33/18

(52) U.S. Cl. 53/459; 383/105; 383/93

(57) ABSTRACT

A convenient disposable container with holder is provided that includes a sheet of material with an inner and outer surface comprised of central and secondary folds seamed at the ends and material edges to create an expandable pocket at the bottom, having a tab to accommodate opening to accept embarrassing waste and having bonding surface areas to form a seal closing the container's contents from site or touch.

### BACKGROUND OF THE INVENTION

The present invention relates to convenient disposable containers, in particular to convenient disposable containers for discretely sealing embarrassing content from view or touch.

In public rest rooms, it is very common to see a sign reading. “Please do not dispose of tampons or other sanitary products in the toilet. Please dispose of them in the waste receptacle.” In many situations, however, the waste receptacle is uncovered. As a guest at a private residence a similar situation is encountered. Having a need to dispose of tampons or other sanitary products many flush these items with the potential of clogging the toilet. The options of clogging a toilet or leaving personal waste products exposed in a trash receptacle is an embarrassing experience for both the guest and for others in the household.

In public restrooms, at times, disposal bags are present. The bags are typically white, narrow and have a small opening. The bags are more of a novelty than they are for disposing of embarrassing waste. The user is at risk of touching and contaminating themselves with the waste. This fact discourages use. Most likely these bags originated from a manufacturer who repurposed an existing bag, to make more bag sales in another market. Simply put, these bags are not convenient to load with any kind of contents, let alone embarrassing waste contents.

Other attempts have been made at solving this problem. Such as, containers made for the exclusive use of disposing tampons and sanitary napkins. A special use container, such as this, has not been a practical solution and as a result are not widely used. Sanitary napkins with an integral disposal means have been produced, but they are limited to exclusive disposal of one product and not available as a general solution to what has been a long existing disposal problem. Other attempts at making a disposal container have lacked convenience, complete sealing capability and discreetness in disposability.

Accordingly there is a need for a convenient disposable container overcoming the limitations of the means noted above and allowing the convenient disposal of embarrassing content, concealing the contents from view or touch.

### SUMMARY OF THE INVENTION

In one aspect, a container for disposing items is provided that includes at least one sheet of material, the at least one sheet of material having a length and a width, and further a central fold and a plurality of secondary folds essentially parallel with the width of the sheet, the folds creating a pair of opposing sides having inner surfaces, and pair of seams connecting the central fold to the pair of opposing sides and the secondary folds to each other along only a portion of the length of the sheet, therewith forming an expandable pocket with the opposing sides extending therefrom open along the length of the container above the seams.

In at least one embodiment, at least one of the opposing sides has a tab folded therein at a corner of the at least one sheet.

In at least one embodiment, at least one of the opposing sides includes an inner bonding surface for selectively bonding opposing sides to each other, therewith selectively encapsulating an item between the opposing sides.

In at least one embodiment, the container includes a removable sheet located between the opposing sides to prevent bonding opposing sides to each other without removal of the sheet.

In at least one embodiment, dimensionally the opposing sides are essentially the same as each other.

In at least one embodiment, the sheet material is opaque.

In at least one embodiment, each of the opposing sides includes an inner bonding surface for selectively bonding opposing sides to each other, therewith selectively encapsulating an item between the opposing sides.

In at least one embodiment, the bonding surface comprises an adhesive.

In at least one embodiment, the adhesive is applied on the opposing sides, within the container, except within the expandable pocket.

In one aspect, a method for disposing items is provided that includes obtaining a container, the container comprising at least one sheet of material, the at least one sheet of material having a length and a width, and further a central fold and a plurality of secondary folds essentially parallel with the width of the sheet, the folds creating a pair of opposing sides having inner surfaces, and pair of seams connecting the central fold to the pair of opposing sides and the secondary folds to each other along only a portion of the length of the sheet, therewith forming an expandable pocket with the opposing sides extending therefrom open along the length of the container above the seams; separating the opposing sides from each other; placing an item between the opposing sides; and encapsulating the item between the opposing sides.

Additional aspects of the present invention will be apparent in view of the description which follows.

### BRIEF DESCRIPTION OF THE FIGURES

FIG. 1 is a perspective view of the convenient disposal container contained in the holder of multiple stacked containers according to at least one embodiment.

FIG. 2 is a perspective view of FIG. 1 with a consumer grasping the corner tab.

FIG. 3 is a perspective view of FIG. 1 with a container partially removed from a holder.

FIG. 4 is a plan view of a container according to at least one embodiment.

FIG. 5 is a perspective view of a consumer opening a container according to at least one embodiment.

FIG. 6 is a perspective view of a consumer holding a container with the bottom side up.

FIG. 7 is a perspective view of a consumer holding a container with the bottom side down, depositing a waste article into a container.

FIG. 8 is a perspective view of a closed container containing a waste article.

FIG. 9 is a perspective view of a consumer depositing a closed container into a waste container.

FIG. 10 is a plan view of a prepared sheet of the material according to at least one embodiment.

FIG. 11 is a perspective view of articulated folds in a sheet of material.

FIG. 12 is a perspective view of a sheet of material closing upon itself.

FIG. 13 is a perspective view of a closed sheet of material with the corner tab being folded back.

FIG. 14 is a plan view of a material sheet with the seams added to the left and right sides.

FIG. 15 is a right side view taken from FIG. 14.

### DETAILED DESCRIPTION OF THE INVENTION

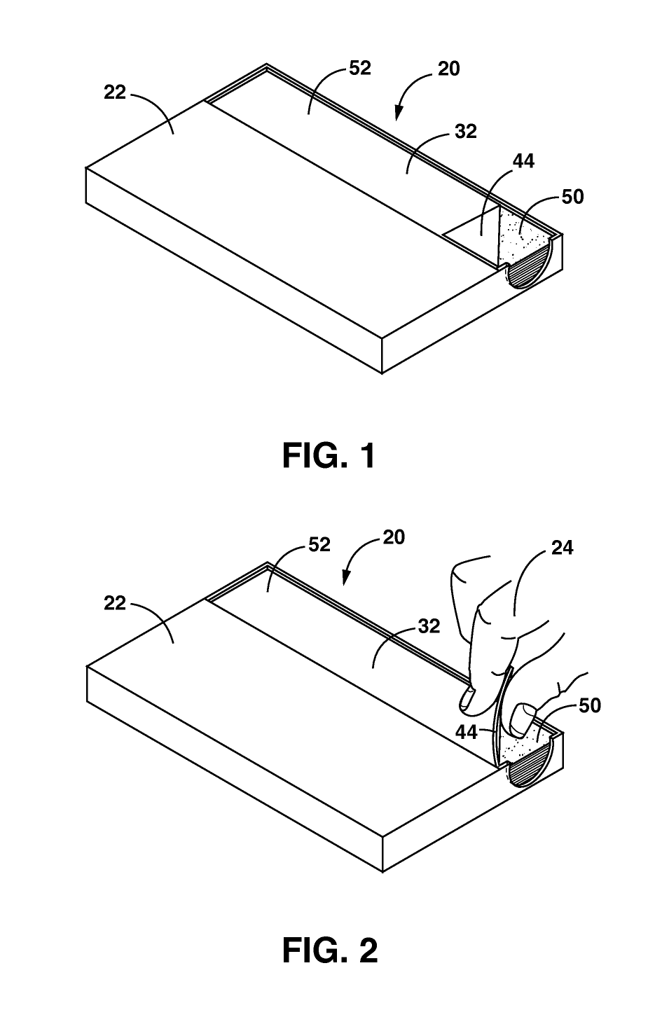

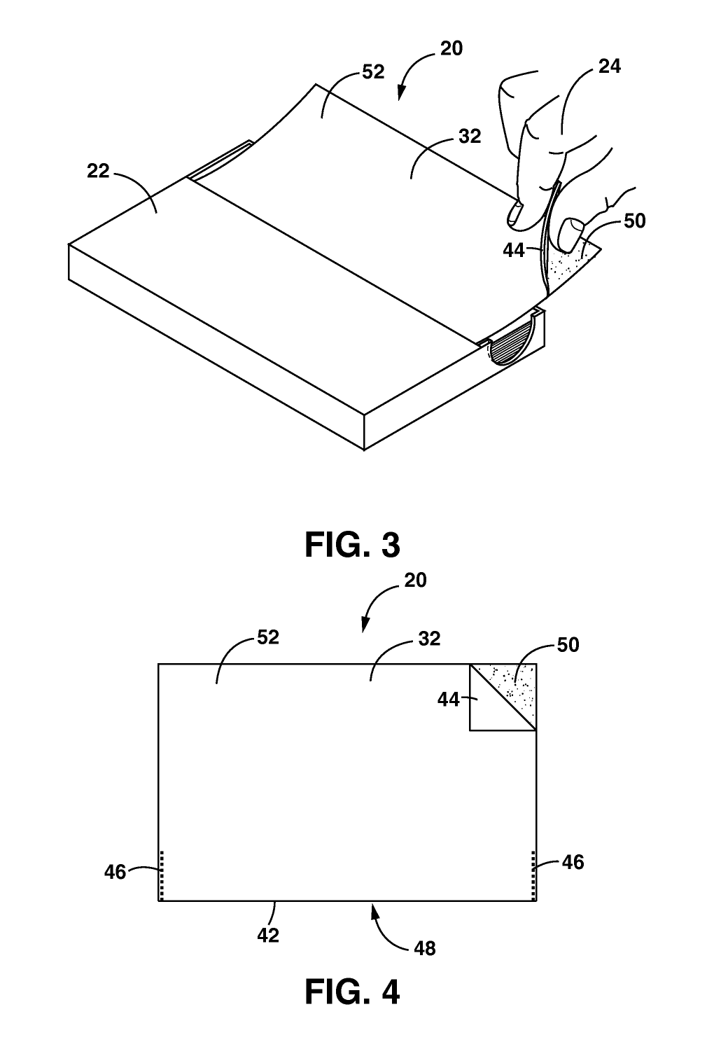

Referring to FIG. 1 through FIG. 3, perspective views of the convenient disposal container 20 contained in the holder 22 of multiple stacked containers 20 according to at least one embodiment are shown. A holder 22 is loaded with one or more convenient disposal containers 20. The containers 20 may be stacked, interleaved or connected by perforations in any suitable fashion to accommodate removal from the holder 22. A container 20 is comprised of a sheet of material 52 with an outer surface 32 exposed to the consumer 24. A corner tab 44 is also exposed to the view of a consumer 24 who grasps the corner tab 44 by the tab's 44 lower and upper sides. Pulling upwardly and laterally the container 20 is removed from holder 22, by the consumer 24, for further use.

FIG. 4 is a plan view of a container 20 according to at least one embodiment. A convenient disposal container 20 has a bottom 48 and one or more seams 46.

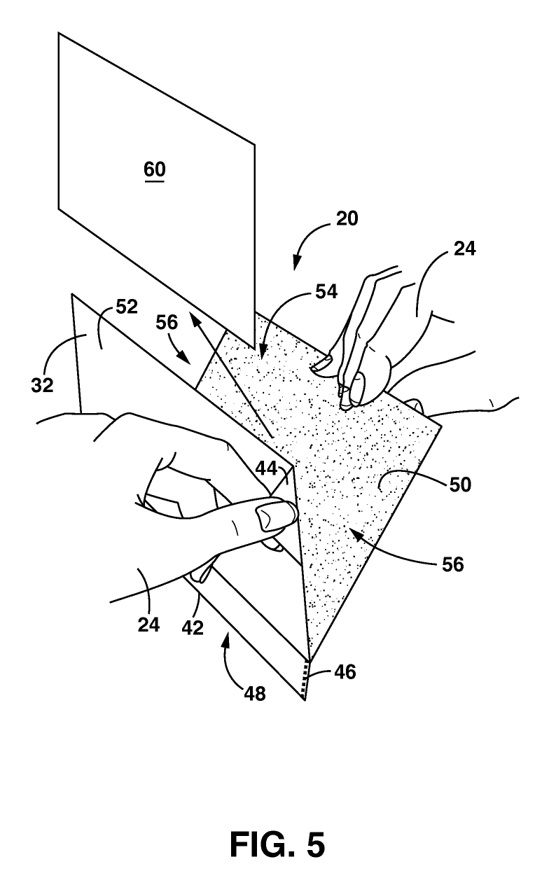

FIG. 5 is a perspective view of a consumer 24 opening a container 20 according to at least one embodiment. One or more sheets of material 52 with one or more bonding surface areas 50 may be present. In this embodiment, facing bonding surface areas 50 are separated one from another to expose an expandable pocket therein. Thus forming an open top 54 and one or more open sides 56, two open sides 56 being shown in this embodiment. Moreover, a sheet of material 60 may be located between the inner surfaces 32 to prevent the bonding surfaces from adhering to each other.

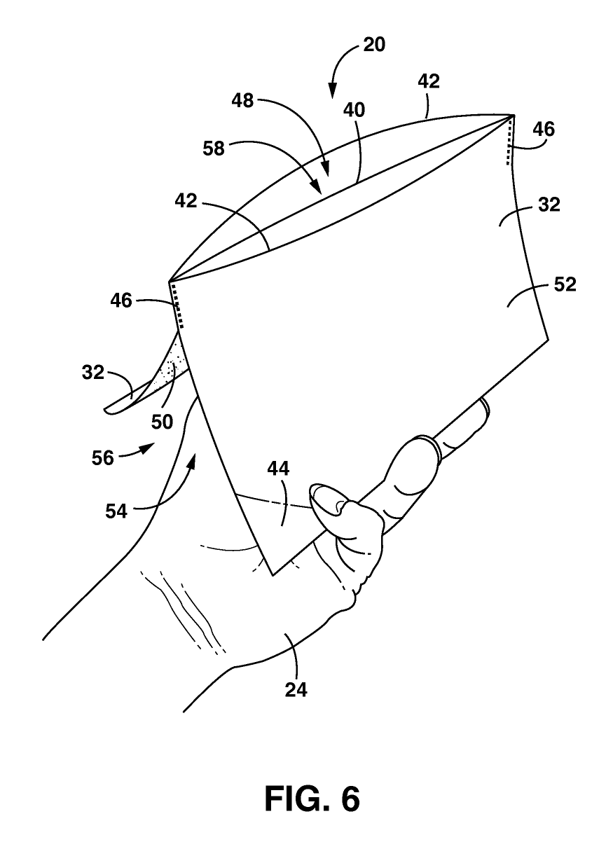

FIG. 6 is a perspective view of a consumer 24 holding a container 20 with a bottom side 48 up. This view discloses a central fold 40 and one or more secondary folds 42. Two secondary folds 42 are shown in this embodiment. The terminating points of central fold 40 and secondary folds 42 are joined together by seams 46. Seams 46 also connect together a portion of the opposite edges of a sheet of material 52, thus forming the expandable pocket 58. Importantly, the seam 46 extends only partially up the sides of the container 20.

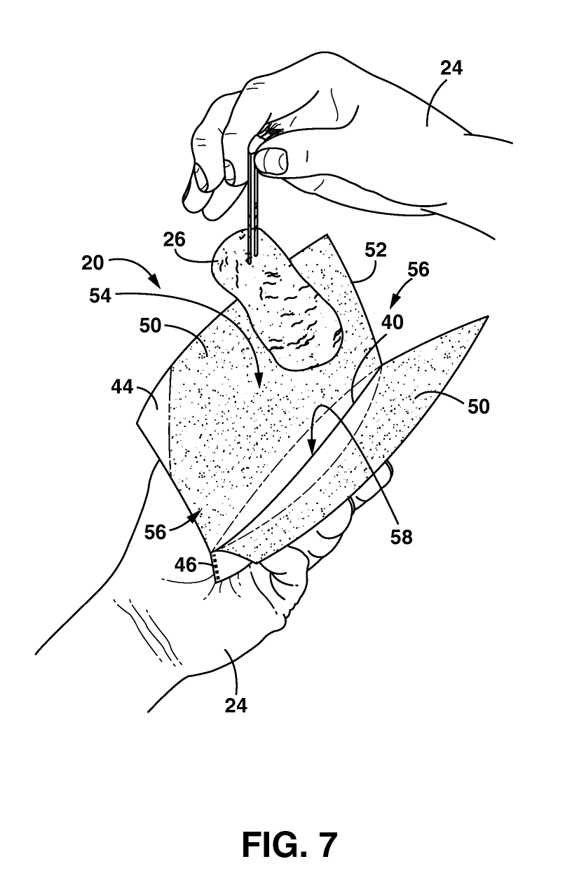

FIG. 7 is a perspective view of a consumer 24 holding a container 20 with the bottom side 48 down, depositing a waste article 26 into a container 20. The open top 54 and open sides 56 make it convenient for a consumer 24 to deposit a waste article 26 into the expandable pocket 58.

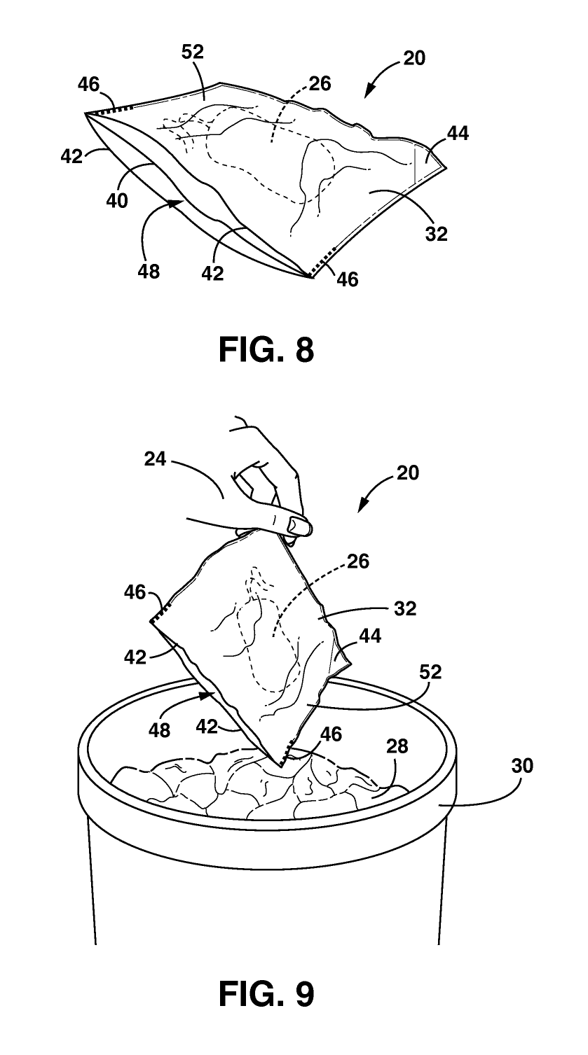

FIG. 8 is a perspective view of a closed container 20 containing a waste article 26. Once a waste article 26 is deposited into a container 20, as shown in FIG. 7. The consumer 24 applies finger pressure to outer surfaces 32, working a sheet of material 52 to enjoin bonding surfaces areas 50. Thus a waste article 26, in container 20, is sealed from outer view and touch.

FIG. 9 is a perspective view of a consumer 24 depositing a closed container 20 in a waste container 30. The container 20 discreetly conceals itself among other waste 28 in the waste container 30.

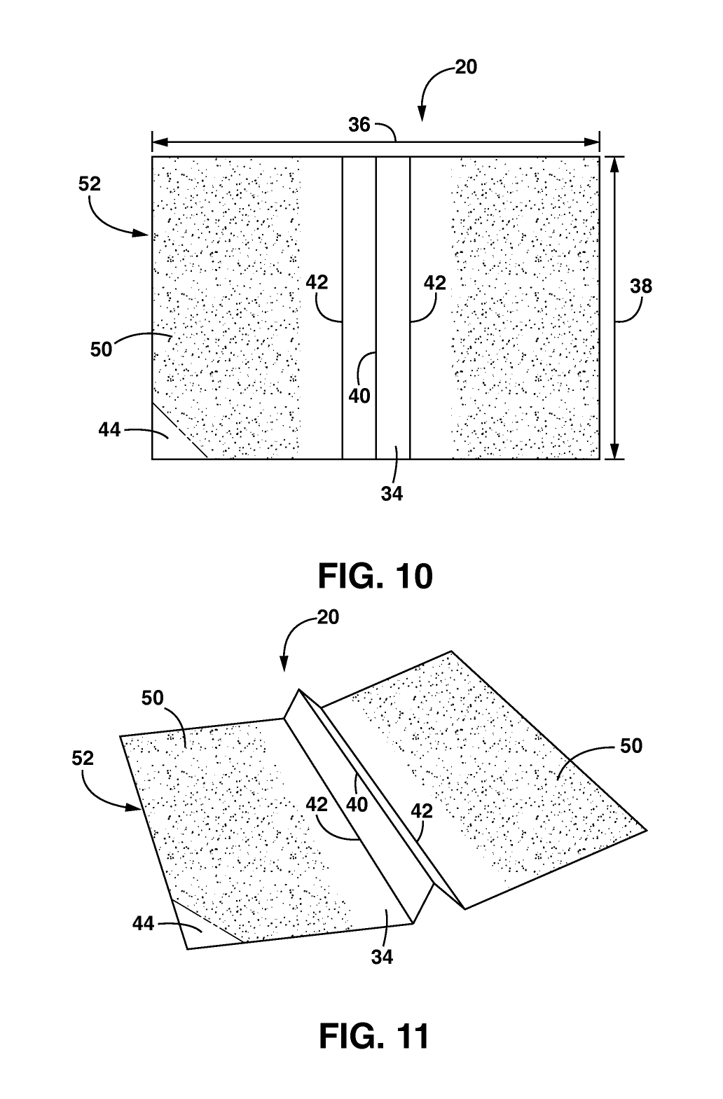

Referring to FIG. 10 through FIG. 15. The present invention is described in the following steps, which are set forth to aid in the understanding of the manufacture of the invention, and should not be construed to limit in any way the scope of the invention as defined in the claims which follow thereafter.

FIG. 10 is a plan view of a prepared sheet of material 52 according to at least one embodiment. The material 52 can be made of plastic, paper, foil or any other flat sheet material 52 suitable for the purpose. The material 52 can be biodegradable or scented. The sheet of material 52 has a length 36 and a width 38. The sheet of material 52 is prepared by application of bonding surface areas 50. Preparation can be by application of an adhesive, texturing of the surface or any other means suitable for creating a bonding surface on the sheet of material 52. As can be seen, the bonding surface is limited to areas of the sheet 52 outside of the area that will define the pocket 58.

As an example of bonding surface areas 50, one adhesive could be a low tack adhesive strong enough to hold a sheet of material 52 together but week enough to allow a sheet of material 52 to be pulled apart with out being torn. More importantly, a low tack adhesive could also be resealed allowing a sheet of material 52 to re-close upon its self.

As another example of bonding surface areas 50, a high tack adhesive could be used. In this instance a sheet of material 60 would separate the bonding surfaces 50 and be removed, allowing a sheet of material 52 to re-close upon its self.

As a third example of bonding surface 50, sheet of material 52 could have a texture applied by pressing or rolling the material to alter the flat plan of sheet 52. In this instance the textures would bond by friction or static electrical charge.

FIG. 11 is a perspective view of articulated folds in a sheet of material 52. The folds can be made by any manual or automated means. A central fold 40 of 180 degrees toward outer surface 32 is placed parallel to the width 38 at a location centered on the length 36. Secondary folds 42 of 180 degrees toward the inner surface 34 are placed parallel to the width 38 at a location equidistant about 0.75 inches from central fold 40. Other suitable dimensions can also be used.

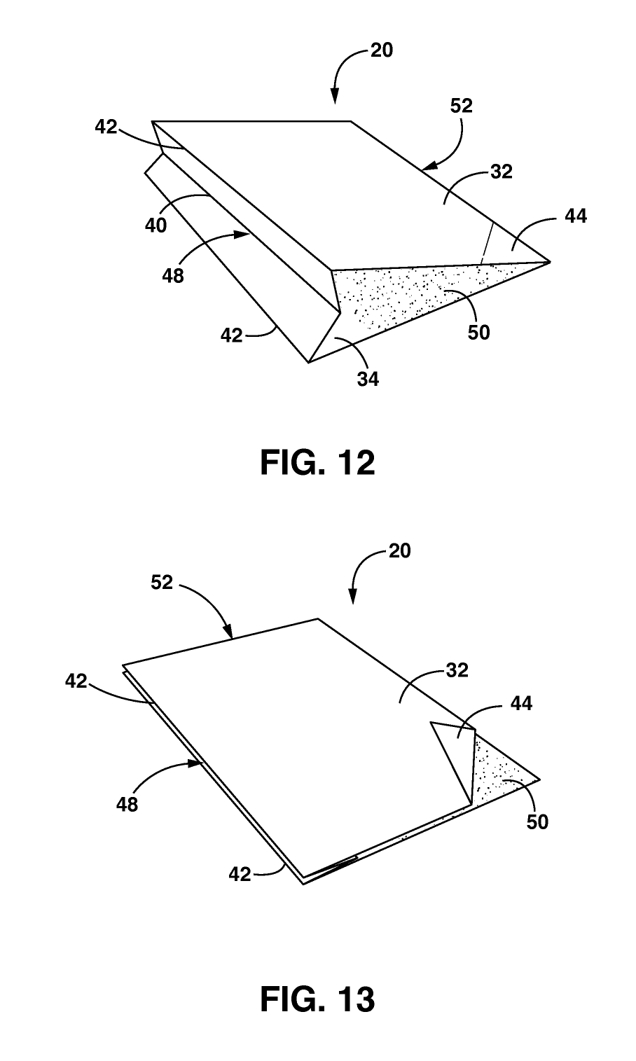

In one embodiment the length 36 is 10 inches and the width 38 is 6.5 inches. In other embodiments the length 26 and the width 38 could be any dimension suitable for the purpose. The sheet of material 52 is 0.001 inches thick or any other dimension suitable for the purpose. FIG. 12 is a perspective view of a sheet of material 52 closing upon itself. FIG. 13 is a perspective view of a closed sheet of material 52 with the corner tab 44 being folded back. In this view the full articulation of the 180 degrees, disclosed above, can be seen.

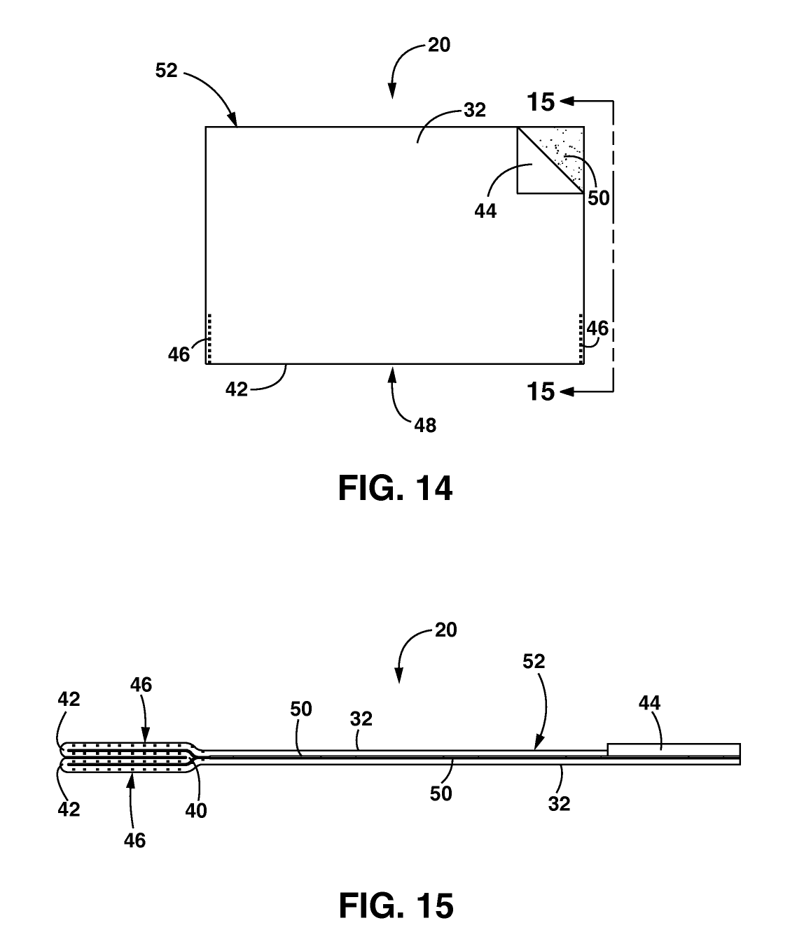

FIG. 14 is a plan view of a material sheet 52 with the seams 46 added to the left and right sides. The seam 46 generally fixes the sheet 52 to itself at the area of the folds. The length of the seams 46 are just over the height of the center fold 40, or about 1 inch in at least one embodiment or any other dimension suitable for the purpose. The seams 46 can be created by application of an adhesive, texturing of the surface of sheet material 52 or any other means suitable for creating a seam 46.

FIG. 15 is a right side view taken from FIG. 14. This view more clearly discloses the finished folded structure of convenient disposable container 20. As can be seen, the seams 46 attach the sides of the sheet 52 to the center fold 40 and each of the secondary folds 42 to each other, thereby creating the expandable pocket 58. Moreover, a sheet of material 60 may be located between the inner surfaces 32 to prevent the bonding surfaces from adhering to each other.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A container for disposing items, the container comprising at least one sheet of material, the at least one sheet of material having a length and a width, and further a central fold and a plurality of secondary folds essentially parallel with the width of the sheet, the folds creating a pair of opposing sides having inner surfaces, and pair of seams connecting the central fold to the pair of opposing sides and the secondary folds to each other along only a portion of the length of the sheet, therewith forming an expandable pocket with the opposing sides extending therefrom open along the length of the container above the seams.

2. The container of claim 1, wherein at least one of the opposing sides has a tab folded therein at a corner of the at least one sheet.

3. The container of claim 1, wherein at least one of the opposing sides includes an inner bonding surface for selectively bonding opposing sides to each other, therewith selectively encapsulating an item between the opposing sides.

4. The container of claim 3, comprising a removable sheet located between the opposing sides to prevent bonding opposing sides to each other without removal of the sheet.

5. The container of claim 1, wherein dimensionally the opposing sides are essentially the same as each other.

6. The container of claim 1, wherein the sheet material is opaque.

7. The container of claim 1, wherein each of the opposing sides includes an inner bonding surface for selectively bonding opposing sides to each other, therewith selectively encapsulating an item between the opposing sides.

8. The container of claim 7, wherein the bonding surface comprises an adhesive.

9. The container of claim 8, wherein the adhesive is applied on the opposing sides, within the container, except within the expandable pocket.

10. A method for disposing items comprising:
obtaining a container, the container comprising at least one sheet of material, the at least one sheet of material having a length and a width, and further a central fold and a plurality of secondary folds essentially parallel with the width of the sheet, the folds creating a pair of opposing sides having inner surfaces, and pair of seams connecting the central fold to the pair of opposing sides and the secondary folds to each other along only a portion of the length of the sheet, therewith forming an expandable pocket with the opposing sides extending therefrom open along the length of the container above the seams;
separating the opposing sides from each other;
placing an item between the opposing sides; and
encapsulating the item between the opposing sides.

11. The method of claim 10, wherein at least one of the opposing sides has a tab folded therein at a corner of the at least one sheet and wherein the opposing sides are separated using the tab.

12. The method of claim 10, wherein at least one of the opposing sides includes an inner bonding surface for selectively bonding opposing sides to each other, the items selectively encapsulated between the opposing sides therewith.

13. The method of claim 12, wherein the container comprises a removable sheet located between the opposing sides to prevent bonding opposing sides to each other without removal of the sheet, the method comprising removing the removable sheet.

14. The method of claim 1, wherein dimensionally the opposing sides are essentially the same as each other.

15. The method of claim 1, wherein the sheet material is opaque.

16. The method of claim 1, wherein each of the opposing sides includes an inner bonding surface for selectively bonding opposing sides to each other, the items selectively encapsulated between the opposing sides therewith.

17. The method of claim 16, wherein the bonding surface comprises an adhesive.

18. The method of claim 17, wherein the adhesive is applied on the opposing sides, within the container, except within the expandable pocket.
